(19) United States
(12) Patent Application Publication
(10) Pub. No.: US 2003/0234293 A1
(43) Pub. Date: Dec. 25, 2003

(54) Radio frequency identification survey monument system

(76) Inventors: Paul C. Sauve, Austin, TX (US); Steven Hunnicutt, Arlington, TX (US)

Correspondence Address: Paul Sauve, 9605 Tea Rose Trail, Austin, TX, 78748, US

(21) Appl. No.: 10/175,313

(22) Filed: Jun. 19, 2002

(51) Int. Cl. G06K 19/06

(52) U.S. Cl. 235/492

(57) ABSTRACT

A radio frequency identification survey monument system that quickly and easily locates a land survey monument and receives important land survey information relating to land where monument is located which was entered by a land surveyor. Information can be transferred to a computer. Radio frequency identification (RFID) technology is combined with land surveying resulting in a new system for improving current system of locating a monument and retrieving data regarding land survey. This invention improves ability to locate monument with accuracy from current technology which uses a magnetometer to locate monument within three (3) to four (4) feet of magnetometer, to a distance of at least fifteen (15) feet or more with the present invention.

### BACKGROUND OF THE INVENTION

1. Field of the Invention

The present invention relates to a radio frequency identification survey monument system for use in connection with survey monument marking and locating systems. The radio frequency identification survey monument system has particular utility in connection with using Radio Frequency Identification (RFID) technology to send valuable information about a land surveying monument to a future surveyor.

2. Description of the Prior Art

Radio frequency identification survey monument systems are desirable to assist land surveyors in locating a land surveying monument and quickly and easily gain access to surveying information regarding land upon which a monument is located.

The use of radio frequency identification systems and the use of survey monument systems are known in the prior art. For example, U.S. Pat. No. 5,734,348 to Aoki, et al discloses a surveying system using GPS receivers. However, the Aoki '348 patent does not use RFID technology, and has further drawbacks of being limited in amount of information that can be stored at the monument site.

U.S. Pat. No. 5,614,913 to Nichols, et al discloses an optimization of survey coordinate transformations that uses GPS for selecting an optimal transformation for purposes of gathering surveying measurements. However, the Nichols '913 patent does not store land surveying data and additionally does not assist a user in locating a land survey monument from fifteen (15) feet or more.

Similarly, U.S. Pat. No. 5,291,703 to Ziegler discloses a survey monument and improved extraction restriction means therefore that has a simple spring clip extracting means to allow easy removal of rod after rod is driven in ground. However, the Zeigler '703 patent does not assist a user is locating a land monument, and can not store all data the present invention is capable of storing for quick and easy retrieval.

Lastly, U.S. Pat. No. 6,144,301 to Frieden discloses an electronic tracking tag that may be attached to various types of physical assets to assist in asset identification. However, the Frieden '301 patent does not assist in locating a monument that may be buried, and has the additional deficiency of working only to locate an asset and does not have a feature wherein a reader receives information or data from an electronic tracking tag.

While the above-described devices fulfill their respective, particular objectives and requirements, the aforementioned patents do not describe a radio frequency identification survey monument system that allows use of Radio Frequency Identification (RFID) technology to locate monument and send valuable information about a land surveying monument to a future surveyor.

The present invention uses the known technology of RFID to improve upon current technology used in land surveying which will greatly decrease amount of time spent in locating land monuments, and improve upon ability to obtain accurate information regarding surveys.

Therefore, a need exists for a new and improved radio frequency identification survey monument system that can be used for locating a land survey monument and retrieving valuable information about a land survey. In this regard, the present invention substantially fulfills this need. In this respect, the radio frequency identification survey monument system according to the present invention substantially departs from the conventional concepts and designs of the prior art, and in doing so provides an apparatus primarily developed for the purpose of locating a land survey monument and retrieving valuable information about a land survey.

### SUMMARY OF THE INVENTION

In view of the foregoing disadvantages inherent in the known types of survey monument systems now present in the prior art, the present invention provides an improved survey monument system, and overcomes the above-mentioned disadvantages and drawbacks of the prior art. As such, the general purpose of the present invention, which will be described subsequently in greater detail, is to provide a new and improved survey monument system and method of using it which has all the advantages of the prior art mentioned heretofore and many novel features that result in a radio frequency identification survey monument system which is not anticipated, rendered obvious, suggested, or even implied by the prior art, either alone or in any combination thereof.

To attain this, the present invention essentially comprises a radio frequency identification survey monument system with a radio frequency identification transponder tag operative to store information and to transmit a signal for marking and identifying a location on a region of land, and a reader operative to excite a transponder and read the signal transmitted by the radio frequency identification transponder tag.

There has thus been outlined, rather broadly, the more important features of the invention in order that the detailed description thereof that follows may be better understood and in order that the present contribution to the art may be better appreciated.

The invention may also include an external antenna for transmitting signals to a reader. There are, of course, additional features of the invention that will be described hereinafter and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved survey monument system that has all of the advantages of the prior art survey monument systems and none of the disadvantages.

It is another object of the present invention to provide a new and improved survey monument system that may be easily and efficiently manufactured and marketed.

An even further object of the present invention is to provide a new and improved survey monument system that has a low cost of manufacture with regard to both materials and labor, and which accordingly is then susceptible of low prices of sale to the consuming public, thereby making such survey monument system economically available to the buying public.

Still another object of the present invention is to provide a new survey monument system that provides in the apparatuses and methods of the prior art some of the advantages thereof, while simultaneously overcoming some of the disadvantages normally associated therewith.

Even still another object of the present invention is to provide a radio frequency identification survey monument system for locating a land survey monument and retrieving valuable information about a land survey. This allows a user with a reader to access valuable information about a land survey quickly and easily, without the need for extensive research. In many cases, research efforts can not only be time consuming, but can be unsuccessful. The present invention also assists in quick, easy and accurate location of a land survey monument without the current confusion caused by mixed signals with barbed wire or other metals on land.

Lastly, it is an object of the present invention to provide a new and improved method of obtaining information about a location of land by receiving a radio frequency signal from a transponder tag located at the location and processing the radio frequency signal to obtain the information about the location. The present invention also operates to locate a land survey monument system by use of a reader.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an overview of the preferred embodiment of the radio frequency identification survey monument system constructed in accordance with the principles of the present invention.

FIG. 2 is an overview of the radio frequency identification survey monument system of the present invention.

FIG. 3 is an overview of the radio frequency identification survey monument system of the present invention.

The same reference numerals refer to the same parts throughout the various figures.

### DESCRIPTION OF THE PREFERRED EMBODIMENT

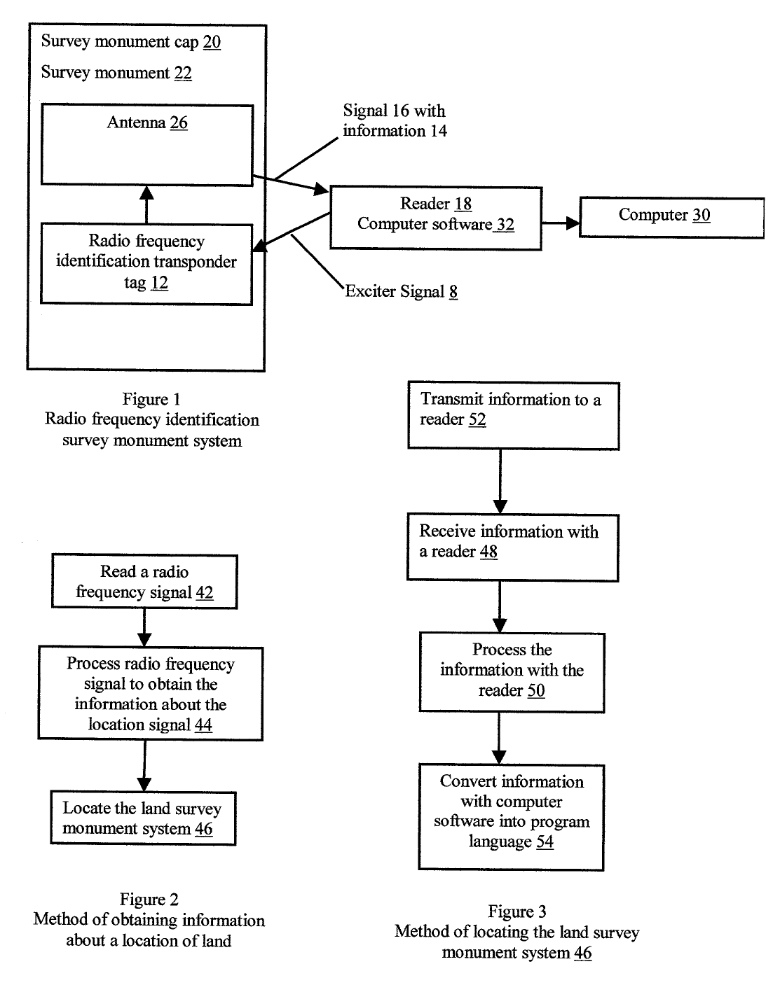

Referring now to the drawings, and particularly to FIGS. 1-3, a preferred embodiment of the radio frequency identification survey monument system of the present invention is shown and generally designated by the reference numeral 10.

In FIG. 1, a new and improved radio frequency identification survey monument system 10 of the present invention for locating a land survey monument and retrieving valuable information about a land survey is illustrated and will be described. More particularly, the radio frequency identification survey monument system 10 has a radio frequency identification transponder tag 12 operative to store information 14 for marking and identifying a location on a region of land and transmit a signal 16 to a reader 18. FIG. 1 also shows a reader 18 operative to excite the transponder tag 12 with exciter signal 8 and receive the signal 16 transmitted by the radio frequency identification transponder tag 12.

FIG. 1 shows a survey monument cap 20 that includes the radio frequency identification transponder tag 12. The transponder tag 12 is operative to allow the reader 18 to provide location information. FIG. 1 shows how the transponder tag 12 is operative to transmit to a reader 18 to allow the reader 18 to provide information 14 regarding at least one of a personal identify of a land surveyor and crew members who set monument, date and weather at time monument was set, type of equipment used to set monument, a depth of a monument, a set of land coordinates, Cadd files and field notes or property descriptions, deed and title information regarding region of land and surrounding land, station and offset information relating to construction plans, and any problems incurred when surveying property or right of way.

FIG. 1 also shows the radio frequency identification survey monument system 10 and illustrates how once it is excited by the reader 18 can read the signal 16 from the transponder tag 12 at a range of at least 15 feet from the reader 18. The reader 18 can read the signal 16 from the transponder tag 12 for a duration of at least one year. Information 14 received by the reader 18 can be transferred from the reader 18 to a computer 30 with computer software 32.

FIG. 1 shows the monument cap 20 and how a survey monument 22 fits within the survey monument cap 20. The survey monument cap 20 can be made of plastic, while the survey monument 22 can be made of concrete, metal or plastic. The transponder tag 12 is operative to continue to transmit the signal 16 to the reader 18 when the transponder tag 12 is buried under ground 24. FIG. 1 shows the transponder tag 12 with an external antenna 26 which can transmit the signal 16 to the reader 18 when the transponder tag 12 is buried under ground 24 and the antenna 26 is above ground 24. The antenna 26 can be a wire.

FIG. 2 shows a method of obtaining information 14 about a location of land by exciting a transponder tag 12 with a reader 18, then receiving a radio frequency signal 16 from a transponder tag 12 located at the location 42, and processing the radio frequency signal to obtain the information 14 about the location 44. FIG. 2 also shows how the reader 18 locates the land survey monument system 46.

FIG. 3 shows a method of locating a land survey monument system 46 wherein information is transmitted to a reader 52 by a transponder tag, received with a reader 48, processed with the reader 50, and converted into a program language with computer software 54.

In use, it can now be understood that a radio frequency identification survey monument system is essential to land surveyors and those who seek survey information about a region of land. The current methods for obtaining survey information are time consuming and can produce inaccurate or incomplete information.

While a preferred embodiment of the radio frequency identification survey monument system has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, any suitable sturdy material such as metal or plastic may be used instead. Also, the survey monument may also be made of heavy-duty plastic, metal, or similar material. And although using Radio Frequency Identification (RFID) technology to send valuable information about a land surveying monument to a future surveyor have been described, it should be appreciated that the radio frequency identification survey monument system herein described is also suitable for quickly and easily detecting a land survey monument in a region of land. Furthermore, a wide variety of land survey monuments may be used instead of the standard metal land survey monument described.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A radio frequency identification survey monument system comprising:
a radio frequency identification transponder tag operative to store information for marking and identifying a location on a region of land and transmit the information to a reader; and
a reader operative to excite the transponder tag and receive and process the signal transmitted by the radio frequency identification transponder tag.

2. The radio frequency identification survey monument system of claim 1 further comprising a survey monument cap that includes the radio frequency identification transponder tag.

3. The radio frequency identification survey monument system of claim 1 wherein the transponder tag is operative to allow the reader to provide location information.

4. The radio frequency identification survey monument system of claim 1 wherein the transponder tag is operative to allow the reader to provide information regarding at least one of a personal identity of a land surveyor and crew members who set monument, date and weather at time monument was set, type of equipment used to set monument, a depth of a monument, a set of land coordinates, Cadd files and field notes or property descriptions, deed and title information regarding region of land and surrounding land, station and offset information relating to construction plans, and any problems incurred when surveying property or right of way.

5. The radio frequency identification survey monument system of claim 1 wherein the reader can read the signal from the transponder tag at a range of at least 15 feet from the reader.

6. The radio frequency identification survey monument system of claim 1 wherein the reader can read the signal from the transponder tag at a range of at least 30 feet from the reader.

7. The radio frequency identification survey monument system of claim 1 wherein the reader can read the signal from the transponder tag for a duration of at least one year.

8. The radio frequency identification survey monument system of claim 1 wherein the reader is operative to transfer information received to a computer.

9. The radio frequency identification survey monument system of claim 2 wherein the survey monument cap is made of a material selected from the group consisting of plastic.

10. The radio frequency identification survey monument system of claim 2 further comprising a survey monument operative to fit within the survey monument cap.

11. The radio frequency identification survey monument system of claim 8 wherein the survey monument is made of a material selected from the group consisting of concrete, metal and plastic.

12. The radio frequency identification survey monument system of claim 8 wherein the information received by the computer is processed by computer software.

13. The radio frequency identification survey monument system of claim 12 wherein the computer software is operative to convert information from the transponder tag to at least one program language.

14. The radio frequency identification survey monument system of claim 1 wherein the transponder tag is operative to continue to transmit the signal to the reader when the transponder tag is buried under ground.

15. The radio frequency identification survey monument system of claim 10 further comprising an external antenna that when above ground and the transponder tag is buried under ground can transmit the signal to the reader.

16. The radio frequency identification survey monument system of claim 11 wherein the antenna is a wire.

17. A method of obtaining information about a location of land including the steps of:
transmitting to a reader with a transponder tag;
receiving a radio frequency signal from a transponder tag located at the location;
processing the radio frequency signal to obtain the information about the location; and
converting the information with computer software into a program language.

18. The method of claim 17 wherein the step of receiving a radio frequency signal includes a step of locating land survey monument system with a reader.

19. The method of claim 18 wherein the step of receiving a radio frequency signal includes the steps of receiving information with a reader and processing the information with the reader.

20. The method of claim 19 including the step of transferring information from the reader to a computer.
